(19) United States
(12) Patent Application Publication
(10) Pub. No.: US 2023/0104312 A1
(43) Pub. Date: Apr. 6, 2023

(54) OBJECT MANAGEMENT SYSTEM

(71) Applicant: Synamon Inc., Tokyo (JP)

(72) Inventor: Wataru TAKEHI, Tokyo (JP)

(21) Appl. No.: 18/063,599

(22) Filed: Dec. 8, 2022

Related U.S. Application Data
(63) Continuation of application No. PCT/JP2022/013888, filed on Mar. 24, 2022.

(30) Foreign Application Priority Data
Mar. 24, 2021 (JP) 2021-050281

(51) Int. Cl. G06T 17/00

(52) U.S. Cl. CPC G06T 17/00

(57) ABSTRACT

In an object management system, a distributed ledger stores a real identifier, which is an identifier for identifying a real object, and a virtual identifier, which is an identifier for identifying a virtual object in a virtual space corresponding to the real object in the real space, in association with each other. Each of the plurality of nodes includes: an information receiving part that receives an identifier for identifying an object and change information about a state change including an operation of the object; an identifier acquisition part that acquires a correspondence identifier which is an identifier of an object corresponding to the identifier, by referencing the distributed ledger; an instruction information generator that generates instruction information for operating the object identified by the correspondence identifier on the basis of the change information; and an instruction information transmitter that transmits the instruction information to the corresponding object.

### CROSS-REFERENCE TO RELATED APPLICATIONS

The present application is a continuation application of International Application number PCT/JP2022/013888, filed on Mar. 24, 2022, which claims priority under 35 U.S.C. § 119(a) to Japanese Patent Application No. 2021-050281, filed on Mar. 24, 2021. The contents of this application are incorporated herein by reference in their entirety.

### BACKGROUND OF THE INVENTION

In recent years, with the rapid development of communication technology, many devices are being connected to a network. Further, with the rapid improvement in computer performance, various virtual worlds, including games, have been constructed in online virtual spaces, and interaction with many people is becoming a reality.

The inventor of the present application has predicted the advent of a world where people establish a place of life in the virtual world as in the real world, since the real world and the virtual world will be mixed while interfering with each other in the not so distant future if the development of communication technology and the improvement in computer performance continue. Further on, in order to work toward realizing such a vision of the future, the inventor of the present application has come to recognize the importance of developing technology for bringing the current world closer to this vision of the future.

### BRIEF SUMMARY OF THE INVENTION

The present disclosure focuses on these points, and its object is to provide a technology for making an object existing in a real space and an object to be realized in a virtual space collaborate with each other.

A first aspect of the present disclosure is an object management system for managing a real object that is an object in a real space and a virtual object that is an object in a virtual space corresponding to the real object. The object management system including: a plurality of nodes; and a distributed ledger shared by each of the plurality of nodes, wherein the distributed ledger includes: an identifier field that stores a real identifier which is an identifier for identifying the real object and a virtual identifier which is an identifier for identifying the virtual object corresponding to the real object, in association with each other, and each of the plurality of nodes includes: an information receiving part that receives, from at least one of the real object or the virtual object, an identifier for identifying the object and change information about a state change including an operation of the object; an identifier acquisition part that acquires a correspondence identifier which is an identifier of an object corresponding to the identifier, by referencing the distributed ledger; an instruction information generator that generates instruction information for operating a corresponding object, which is the object identified by the correspondence identifier, on the basis of the change information; and an instruction information transmitter that transmits the instruction information to the corresponding object.

It should be noted that any combination of the above constituent elements, the expression of the present disclosure converted between a method, an apparatus, a system, a computer program, a data structure, a recording medium, and the like, is also effective as an embodiment of the present disclosure. Further, to provide a computer program or to update a part of the computer program, a computer-readable storage medium on which the computer program is recorded may be provided, or the computer program may be transmitted through a communication line.

### BRIEF DESCRIPTION OF THE DRAWINGS

FIG. 1 illustrates the future world view assumed by an object management system according to an embodiment.

FIG. 2 illustrates an outline of the object management system according to the embodiment.

FIG. 3 schematically shows a data structure of a distributed ledger according to the embodiment.

FIG. 4 schematically shows a configuration of a node according to the embodiment.

FIG. 5 is a flowchart for illustrating information processing executed by nodes according to the embodiment.

FIG. 6 illustrates a world view assumed by an object management system S according to Variation 3 of the embodiment.

### DETAILED DESCRIPTION OF THE INVENTION

Hereinafter, the present disclosure will be described through exemplary embodiments, but the following exemplary embodiments do not limit the disclosure according to the claims, and not all of the combinations of features described in the exemplary embodiments are necessarily essential to the solution means of the disclosure.

### Future World Assumed by the Embodiment

Prior to describing an object management system according to the embodiment of the present disclosure, a future world assumed by the present disclosure will be described first.

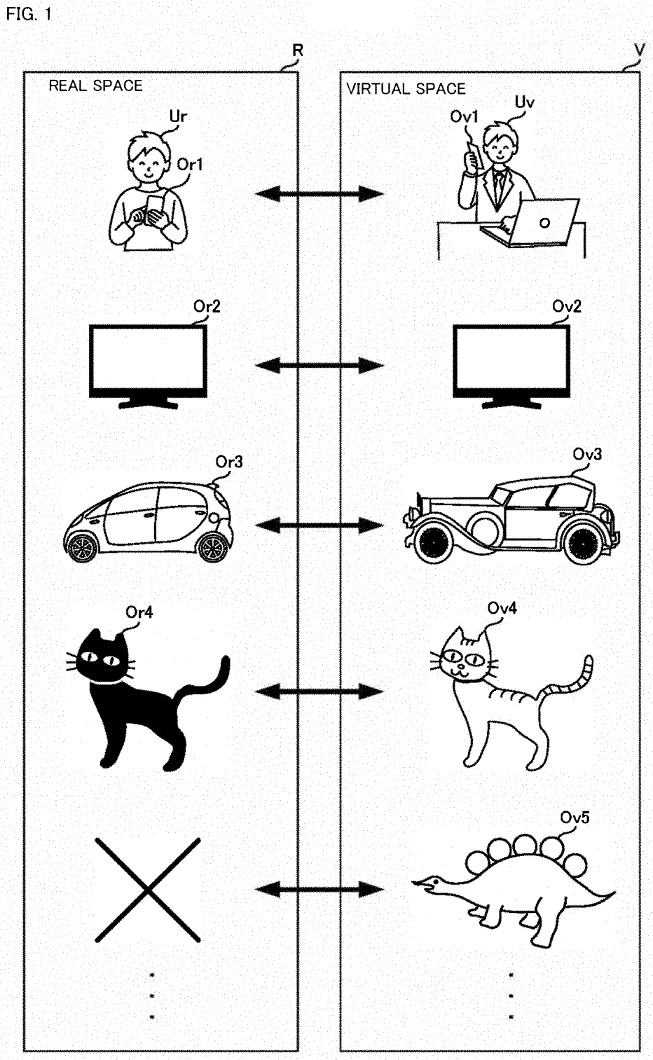

FIG. 1 illustrates the future world view assumed by the object management system according to the embodiment. The object management system according to the embodiment assumes the advent of a world (hereinafter, referred to as a “future world”) in which a real space R where people are active and a virtual space V created by a computer are fused, and the two spaces exist in relation to each other while being independent of each other.

In the future world, an object existing in the real space R and an object existing in the virtual space V are based on having a one-to-one correspondence. Here, the “object” is a unit associated between the real space R and the virtual space V, and is a living creature, an industrial product, a natural object, or the like, for example. As shown in FIG. 1, a user Ur, who is a person in the real space R, is an example of the object in the real space R, and a user Uv, who is a user in the virtual space V corresponding to the user Ur, is an example of the object in the virtual space V. Hereinafter, the user Ur in the real space R and the user Uv in the virtual space V will simply be referred to as a “user U” when they are not distinguished from each other.

Hereinafter, in the present specification, a real object which is an object in the real space R is denoted by Or, and a virtual object which is an object in the virtual space V is denoted by Ov. For example, FIG. 1 illustrates a first real object Or1 as an object of a mobile phone in the real space R, a second real object Or2 as an object of a television in the real space R, a third real object Or3 as an object of an automobile in the real space R, and a fourth real object Or4 as an object of a cat in the real space R.

A first virtual object Ov1 is also exemplified as a virtual object corresponding to the first real object Or1. Similarly, a second virtual object Ov2, a third virtual object Ov3, and a fourth virtual object Ov4 are exemplified as virtual objects corresponding to the second real object Or2, the third real object Or3, and the fourth real object Or4, respectively.

A fifth virtual object Ov5 is an object of a dinosaur. Needless to say, prehistoric life such as dinosaurs does not exist in the real space R. In this manner, virtual objects Ov and real objects Or do not necessarily have a one-to-one correspondence relationship in the future world. There may be an object, such as the fifth virtual object Ov5, which exists only in the virtual space V, or there may be an object (not shown) that exists only in the real space R.

In FIG. 1, both the second real object Or2 and the second virtual object Ov2 are objects of liquid crystal televisions, and both the third real object Or3 and the third virtual object Ov3 are objects of automobiles. Here, the second real object Or2 and the second virtual object Ov2 have the same outward appearance. On the other hand, while the outward appearance of the third real object Or3 is a small car in a modern style, the third virtual object Ov3 is an automobile with a classic look. Also, the fourth real object Or4 and the fourth virtual object Ov4, which are objects of cats, have different outward appearances. As described above, (i) the real object Or and (ii) the virtual object Ov corresponding to said real object Or are not necessarily the same in outward appearance, even if the types of objects are the same.

Further, although the outward appearance of the second real object Or2 changes due to scratches and stains from use, since the second virtual object Ov2 is electronic data, the outward appearance of the second virtual object Ov2 can be kept as good as new or can also reflect aging deterioration in a similar manner as the second real object Or2.

In the future world, the real space R and the virtual space V are related to each other. Therefore, when the user Ur in the real space R operates objects of electric appliances in the real space R, objects of electric appliances in the virtual space V corresponding thereto can also be operated in conjunction with the objects of electric appliances operated by the user Ur in the real space R. On the other hand, in the future world, the real space R and the virtual space V are also independent of each other. Therefore, the user Uv in the virtual space V can make a call to the first real object Or1 using the first virtual object Ov1, which is the object of a smartphone, for example. In this case, the first real object Or1 and the first virtual object Ov1 are in an equal relationship, and are assigned different telephone numbers. Social life is organized also in the virtual space V, and a user who is based in the virtual space V also exists in the future world.

As described above, the inventor of the present application assumes, as the future world, a world where every real object Or which can be observed in the real space R is managed and virtual objects Ov corresponding to the respective real objects Or are also managed, such that the real space R and the virtual space V exist in relation to each other while being independent of each other.

### Purpose of the Present Disclosure

There is still a great gap between the future world and the current world. In the future world, it is fundamental that corresponding virtual objects Ov exist even for real objects Or that are not connected to the network, such as wild animals and stationery, but it takes a lot of work to do that in the current world. Therefore, as the first step to bring the current world closer to the future world, in addition to a user, only devices connectable to a network, such as Internet of Things (IoT) devices will be dealt with in the present disclosure. Note that, when an object is recognized by combining sensing devices such as light detection and ranging (LiDAR), for example, and its result can be reflected as a virtual object via a network by a function of the LiDAR itself or by combining other communication devices, such devices will be dealt with in the present disclosure as connectable devices, even when the devices cannot be connected to the network by themselves.

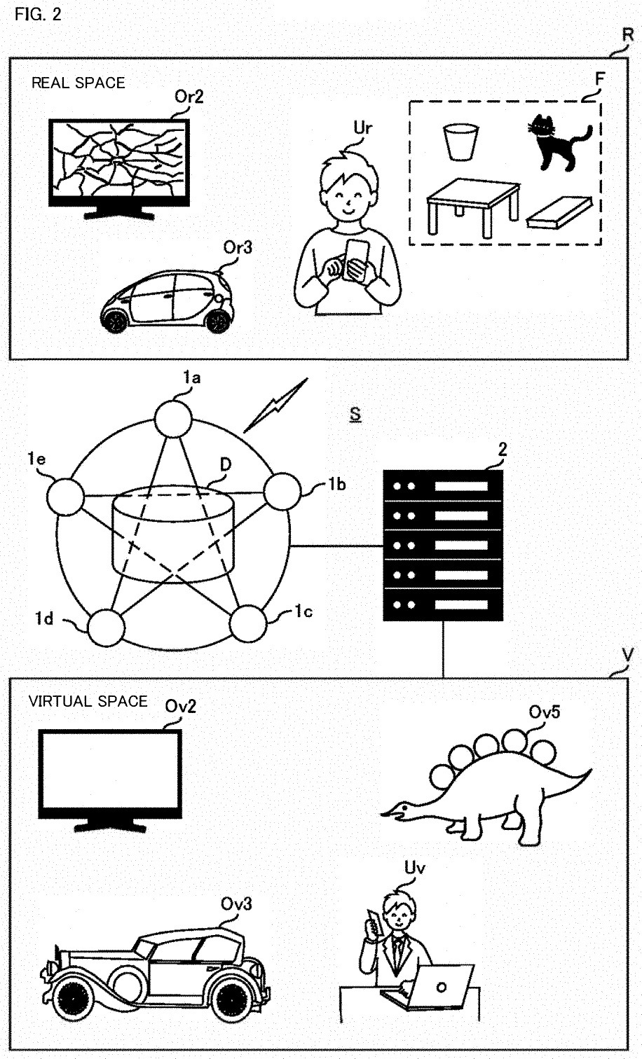

FIG. 2 illustrates an outline of the object management system S according to the embodiment. The object management system S according to the embodiment is a system for managing a real object Or which is an object in the real space R and a virtual object Ov which is an object in the virtual space V corresponding to the real object Or. The object management system S includes a plurality of nodes 1, a virtual space management server 2, and a distributed ledger D.

The distributed ledger D is a database that stores data for managing the real object Or and the virtual object Ov corresponding to the real object Or, and is shared by the plurality of nodes 1. FIG. 2 shows an example in which the distributed ledger D is managed by five nodes 1 (a first node 1a, a second node 1b, a third node 1c, a fourth node 1d, and a fifth node 1e). The number of nodes 1 for managing the distributed ledger D is not limited to five, may be any number greater than or equal to three, and is preferably an odd number in consideration of facilitating a majority vote. Hereinafter, the nodes 1 will simply be referred to as the “node 1,” unless each node 1 needs to be distinguished.

Among the real objects Or, the distributed ledger D according to the embodiment manages objects connectable to a communication network N such as the Internet. Therefore, as exemplified in FIG. 2, the distributed ledger D does not manage offline objects F, such as a living creature such as a cat, natural objects such as rocks and mountains, and industrial products without a communication function such as a cup, a desk, and a notebook. Therefore, in the object management system S according to the embodiment, corresponding virtual objects Ov do not exist for the offline objects F among the real objects Or. Further, as described above, a real object Or corresponding to the virtual object Ov does not exist for an object (e.g., prehistoric life, an imaginary object, or the like) that does not exist in the real world. In that sense, the distributed ledger D according to the embodiment allows the existence of an object that does not have a corresponding object in the real space R or the virtual space V. A data structure of the data managed by the distributed ledger D will be described later in detail.

The virtual space management server 2 is a server that manages the virtual space V. The virtual space management server 2 manages a construction of the virtual space V as well as creation, change, operation, obliteration, and the like of the virtual space V, and realizes activities performed in the virtual space V. The virtual space management server 2 may independently exist as a server different from the node 1, as shown in FIG. 2, or the node 1 may function as the virtual space management server 2.

In the object management system S according to the embodiment, the node 1 is connected in a communicable manner to the real objects Or managed by the distributed ledger D via the communication network N. When the node 1 receives some state change (for example, change of state including a new entry, being operated or stopped, ownership change, disposal, or the like) of the real object Or, the node 1 stores information about the state change in the distributed ledger D. The virtual space management server 2 transmits, to the virtual object Ov corresponding to the real object Or, an operation instruction corresponding to the state change registered in the distributed ledger D.

In addition, when the state of the virtual object Ov in the virtual space V is changed, the virtual space management server 2 registers information about the state change in the distributed ledger D. The node 1 transmits, to the real object Or corresponding to the virtual object Ov, an operation instruction corresponding to the state change registered in the distributed ledger D. In FIG. 2, a screen of the second real object Or2, which is the object of the television, is cracked. In this manner, the outward appearance and function of the object existing in the real space R may change over time. On the other hand, in FIG. 2, a screen of the second virtual object Ov2 corresponding to the second real object Or2 has no cracks, and the second virtual object Ov2 preserves its valuable state.

The distributed ledger D manages the virtual objects Ov by associating a “credit score” with each virtual object Ov. The credit score is a score indicating the degree of change over time to be reflected on the virtual object Ov. When the credit score associated with the virtual object Ov is low, the virtual space management server 2 increases the degree of reflecting change over time on the virtual object Ov, compared to the case where the credit score is high. Conversely, when the credit score associated with the virtual object Ov is high, the virtual space management server 2 delivers the virtual object Ov as good as new, without reflecting a malfunction or the like due to change over time. In this sense, the credit score is an index indicating the reliability and value of the virtual object Ov.

Thus, by managing the real object Or and the virtual object Ov using the distributed ledger D, the object management system S can make the real object Or and the virtual object Ov collaborate while keeping them independent of each other.

### <Data Structure of the Distributed Ledger D>

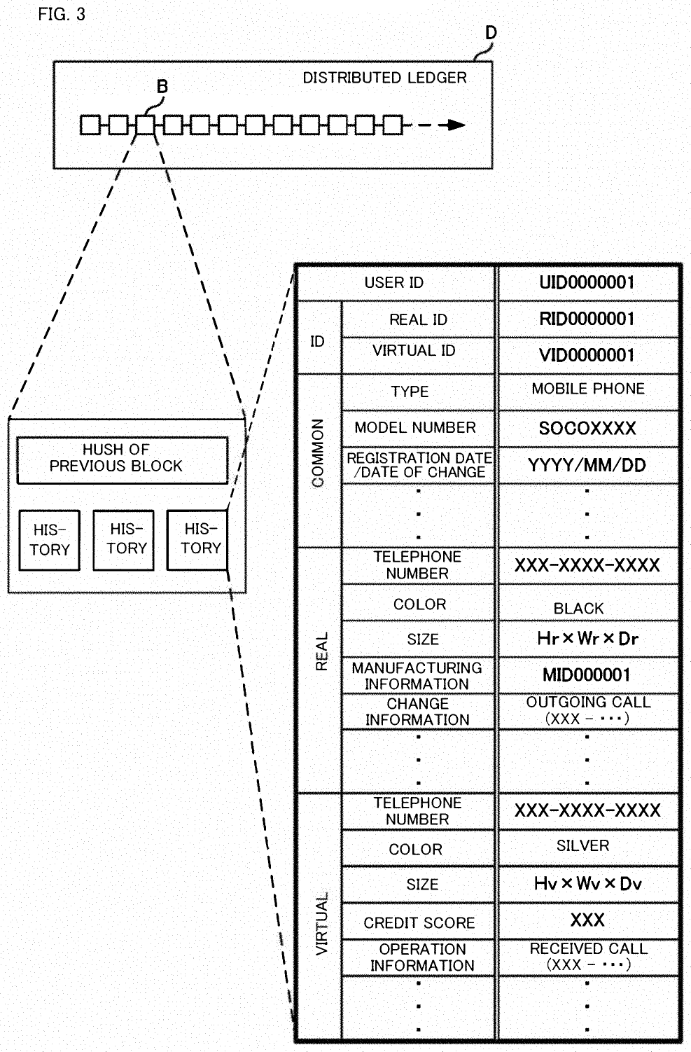

FIG. 3 schematically shows the data structure of the distributed ledger D according to the embodiment. More specifically, FIG. 3 shows an example in which the distributed ledger D is achieved using blockchain technology. As shown in FIG. 3, the blockchain has a data structure consisting of a plurality of blocks B linked together one after the other, with a block B that packages a small amount of information as a unit. Since it is a known technology, detailed explanation is omitted.

As shown in FIG. 3, each block B constituting the blockchain stores (i) a hash value of the previous block B in a connection relation and (ii) one or a plurality of pieces of history data (so-called transaction data). Each piece of history data includes a plurality of fields. Specifically, the history data includes an identifier field, a common field, a real field, a virtual field, and a user field.

The identifier field stores (i) a real identifier which is an identifier for identifying the real object Or and (ii) a virtual identifier which is an identifier for identifying the virtual object Ov corresponding to the real object Or, in association with each other. By referring to the identifier field, the node 1 and the virtual space management server 2 can identify the virtual object Ov corresponding to the real object Or, and vice versa. When only one of the real identifier and the virtual identifier is stored in the identifier field and the other is not stored, this means that the object whose identifier is not stored in the identifier field does not exist. For example, since a corresponding real object Or does not exist for the fifth virtual object Ov5 in FIG. 1, a real identifier is not stored in the identifier field.

The common field stores common information which is information common to the real object Or and the virtual object Ov. Examples of the common information include information indicating (i) types of objects, such as a television and an automobile, (ii) a product model number, (iii) a registration date on which an object is registered in the distributed ledger D, (iv) a date of change on which the state change is registered, or the like. Note that, in the case where the real object Or and the virtual object Ov have different forms, such as the third real object Or3 and the third virtual object Ov3 shown in FIG. 1, the product model number is not stored in the common filed.

The real field stores unique information which is information unique to the real object Or. As a specific example, when the real object Or is a mobile phone, the real field includes (i) information indicating the telephone number assigned to the real object Or, (ii) color of the outward appearance, (iii) size, (iv) manufacturing information for manufacturing the mobile phone which is the real object Or, and (v) change information of the mobile phone. Similarly, the virtual field stores virtual information that is information unique to the virtual object Ov corresponding to the real object Or. Unlike the real field, the virtual field also includes the credit score.

In the object management system S according to the embodiment, the real object Or and the corresponding virtual object Ov are, though related, independent of each other. Therefore, as shown in FIG. 3, different telephone numbers are assigned to the real object Or of the mobile phone and the corresponding virtual object Ov, and are stored in the real field and the virtual field, respectively. The real object Or and the virtual object Ov operate independently of each other, and their operation histories differ from one another. For example, when making a call from the real object Or to the corresponding virtual object Ov, information about an outgoing call is stored in the real field and information about a received call is stored in the virtual field. Each time the change information of the real object Or or the change information of the virtual object Ov is generated, the distributed ledger D stores each object's operation history by storing the generated change information as a history. Thus, the node 1 can trace back and confirm each object's operation.

Although not shown in FIG. 3, the same telephone number may be assigned to the real object Or of the mobile phone and the corresponding virtual object Ov. In this case, one of the real object Or of the mobile phone and the corresponding virtual object Ov will behave like a copier device of the other. That is, when a third party makes a telephone call to the same telephone number, the real object Or and the virtual object Ov simultaneously receive the call, and the user U can receive the call from either the real object Or or the virtual object Ov. This is an example of a collaboration between the real object Or and the virtual object Ov.

### <Functional Configuration of the Node 1 According to the Embodiment>

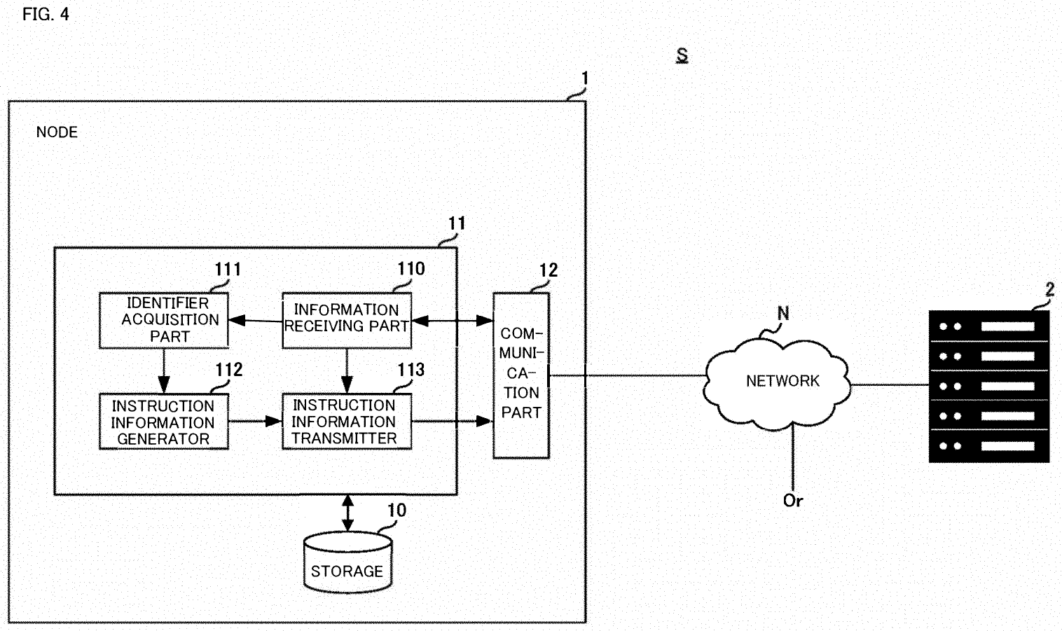

FIG. 4 schematically shows a configuration of the node 1 according to the embodiment. The node 1 includes a storage 10, a controller 11, and a communication part 12. In FIG. 4, arrows indicate main data flows, and there may be data flows not shown in FIG. 4. In FIG. 4, each functional block represents a function unit configuration, not a hardware (device) unit configuration. Thus, the functional blocks shown in FIG. 4 may be implemented in a single device or may be implemented separately in a plurality of devices. Data may be exchanged between the functional blocks via any means, including a data bus, a network, a portable storage medium, or the like.

The storage 10 is a mass storage device, such as a hard disk device (HDD) or a solid state drive (SSD), that stores (i) a read only memory (ROM) which stores a basic input output system (BIOS) for a computer, and the like that realizes the node 1, (ii) a random access memory (RAM) which is a work area of the node 1, (iii) an operating system (OS) and application programs, and (iv) various types of information, such as data of a distributed ledger D shared by other node 1, to be referenced when executing the application programs.

The controller 11 is a processor such as a central processing unit (CPU), a graphics processing unit (GPU), or the like of the node 1, and functions as an information receiving part 110, an identifier acquisition part 111, an instruction information generator 112, and an instruction information transmitter 113 by executing a program stored in the virtual space management server 2.

The communication part 12 is an interface through which the node 1 communicates with an external device, and can be realized by using a known wired or wireless communication module. Hereinafter, when the node 1 communicates with an external device, the description of the communication part 12 may be omitted assuming that communication is performed via the communication part 12.

FIG. 4 shows an example in which the node 1 is configured by a single device. However, the node 1 may be realized by computing resources such as a plurality of processors and memories, such as a cloud computing system, for example. In this case, each unit constituting the controller 11 is realized by at least one processor among a plurality of different processors executing a program.

The information receiving part 110 receives, from at least one of the real object Or or the virtual object Ov, an identifier for identifying the object and change information about the state change including the object's operation. The identifier acquisition part 111 references the distributed ledger D to acquire a correspondence identifier which is an identifier of an object corresponding to the identifier acquired by the information receiving part 110.

The instruction information generator 112 generates instruction information for operating a corresponding object, which is an object identified with the correspondence identifier, on the basis of the change information acquired by the information receiving part 110. For example, suppose the information receiving part 110 receives an unlocking operation of a front door in the virtual space V as the change information from the virtual object Ov of a smart lock that controls a lock of the front door. In this case, the identifier acquisition part 111 acquires an identifier of the real object Or, which is a corresponding object corresponding to the virtual object Ov of the smart lock. The instruction information generator 112 generates instruction information for unlocking the real object Or of the smart lock, which is the corresponding object.

The instruction information transmitter 113 transmits the instruction information generated by the instruction information generator 112 to the corresponding object. As a result, the real object Or of the smart lock, which is the corresponding object in the real space R, performs the unlocking operation, and the front door in the real space R is unlocked.

Here, upon receiving a notification to the effect that the operation has been completed from the real object Or of the smart lock that has completed the unlocking operation, the instruction information transmitter 113 notifies the virtual space management server 2 of the completion of the operation. In response to the reception of an operation completion notification from the instruction information transmitter 113, the virtual space management server 2 may reflect the content of the notification in the virtual space. For example, in order to make it clear that both the real space R and the virtual space V are in a synchronized state, the virtual space management server 2 may add a user-specified color to the outline of an object for displaying a message (not shown) in the virtual space V, thereby visually notifying that the real space R and the virtual space V are in a synchronized state. Conversely, when the real object Or and the virtual object Ov are not in a synchronized state for some reason, the virtual space management server 2 may add a predetermined color to the outline of the object for displaying a message.

Further, suppose the user Ur in the real space R purchases the third real object Or3, which is the object of the automobile in the real space R. In this case, the information receiving part 110 acquires the real identifier for identifying the third real object Or3, and acquires information indicating that the real identifier is newly registered as the change information in the distributed ledger D. The identifier acquisition part 111 generates a new virtual identifier for identifying the third virtual object Ov3 corresponding to the third real object Or3, and registers the new virtual identifier in the distributed ledger D. The instruction information generator 112 generates instruction information indicating that the third virtual object Ov3 is newly generated.

The instruction information transmitter 113 transmits the instruction information indicating that the third virtual object Ov3 is newly generated to the virtual space management server 2. The virtual space management server 2 generates a new third virtual object Ov3 in the virtual space V in accordance with the instruction information received from the instruction information transmitter 113. In this manner, the node 1 functions as an object management server that manages the real space R and the virtual object Ov. By managing the real object Or and the virtual object Ov using the distributed ledger D, the object management system S according to the embodiment can make the real object Or and the virtual object Ov collaborate while keeping them independent of each other.

With the purchase of a vehicle by the user Ur in the real space R, an auto manufacturer or a car dealer may provide a virtual object Ov, which is created or supervised by the auto manufacturer or the car dealer, to the virtual space management server 2 as proof of ownership of the vehicle. In this case, the virtual space management server 2 may newly generate the provided virtual object Or in the virtual space V.

### <Processing Flow of an Information Processing Method Executed by the Node 1>

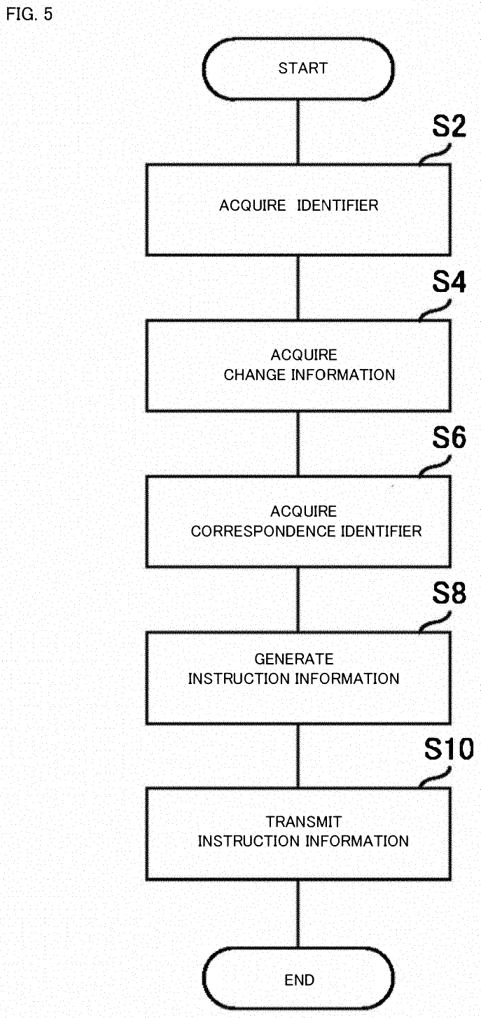

FIG. 5 is a flowchart for illustrating information processing executed by the node 1 according to the embodiment. The process in the flowchart starts upon activation of the node 1, for example.

The information receiving part 110 receives and acquires, from at least one of the real object Or or the virtual object Ov, an identifier for identifying the object (S2). The information receiving part 110 receives and acquires, from at least one of the real object Or or the virtual object Ov, change information about a state change including the object's operation (S4).

The identifier acquisition part 111 references the distributed ledger D and acquires a correspondence identifier which is an identifier of an object corresponding to the identifier acquired by the information receiving part 110 (S6). The instruction information generator 112 generates instruction information for operating a corresponding object, which is an object identified with the correspondence identifier, on the basis of the change information acquired by the information receiving part 110 (S8).

The instruction information transmitter 113 transmits the instruction information generated by the instruction information generator 112 to the corresponding object (S10). When the instruction information transmitter 113 transmits the instruction information to the corresponding object, the process of this flowchart ends.

After the instruction information transmitter 113 has transmitted the instruction information to the corresponding object, the virtual space management server 2 may receive information indicating that the state of the corresponding object has changed or delivery confirmation information from the corresponding object. By doing this, the virtual space management server 2 can let the user Uv in the virtual space V grasp the state of the corresponding object. Further, after the instruction information transmitter 113 transmitted the instruction information to the corresponding object, the information receiving part 110 may periodically transmit a signal to the corresponding object to obtain its state information in order to grasp the state of the corresponding object. Cases in which the information receiving part 110 will periodically grasp the state of the corresponding object may be set by the object management system S in advance, or may be set by the user U at the time of initial registration. An example is a case where an operation instruction is sent to the real object Or.

### <Effect of the Node 1 According to the Embodiment>

As described above, by managing the real object Or and the virtual object Ov using the distributed ledger D, the node 1 according to the embodiment can make the real object Or and the virtual object Ov collaborate while keeping them independent of each other.

### <Usage Scenes of the Object Management System S According to the Embodiment>

Next, various usage scenes of the object management system S according to the embodiment will be described.

### <First Usage Scene>

A first usage scene of the object management system S according to the embodiment is linkage between the real object Or and the virtual object Ov. For example, when the user Uv in the virtual space V turns on an object of a light in an object of his/her home in the virtual space, a corresponding light in his/her home in the real space R is lit. This can be realized by the virtual space management server 2 transmitting an identifier of the virtual light object and information on a lighting operation to the node 1, and the node 1 transmitting a lighting instruction to a corresponding real light object. Alternatively, this can be realized by the virtual space management server 2 directly receiving the lighting instruction via a communication device installed in the virtual space management server 2, in a case where the light in the real space R is an IoT device. Thus, the user Ur in the real space R can turn on the light of his/her home in the real space R by turning on the light of his/her home in the virtual space V by operating a smartphone or the like before entering home, for example. The object management system S can realize similar operations not only with lighting equipment but also with other equipment that can communicate with the node 1. The similar operations include turning on/off an air conditioner, starting a washing machine, locking/unlocking a lock, scheduling recordings, or the like.

### <Second Usage Scene>

A second usage scene of the object management system S according to the embodiment is a reflection of ownership. When a user Ur in the real space R declares to the node 1 that he/she owns a real object Or, the node 1 registers, in the distributed ledger D, that said real object Or is property of said user Ur. In order to realize this, the distributed ledger D includes the user field for storing a user identifier for identifying a user who is an owner of an object, as shown in FIG. 3.

When the registration of the real object Or is completed, the virtual space management server 2 registers a virtual object Ov corresponding to the real object Or in the distributed ledger D in association with a user Uv (the user Ur in the real space R). If a virtual object Ov does not exist in the virtual space V, the virtual space management server 2 newly generates a virtual object Ov.

Here, the user Ur in the real space R may capture the real object Or, for which he/she has declared ownership, from various angles using a photographing device such as a smartphone, and transmit object images, which are the captured still images or moving images, to a predetermined server (not shown). The server that has received the object images may specify the real object Or, which is a subject of the image capturing, by analyzing the object images and register the virtual object Ov corresponding to said real object Or in the distributed ledger D together with a model number or the like. By doing this, when the user Ur purchases a new real object Or in the real space R, the object management system S can cause the corresponding virtual object Ov to appear in the virtual space V.

On the other hand, when the user Uv purchases a virtual object Ov in the virtual space V and installs the virtual object Ov at a predetermined installation location in the virtual space V, the object management system S performs order processing for a corresponding real object Or in the real space R and delivers goods to an installation location in the real space R corresponding to the installation location of the virtual space V. Thus, the object management system S can substitute shopping in the real space R with shopping in the virtual space V.

Here, when a virtual object Ov corresponding to a real object Or does not exist, the virtual space management server 2 may digitally generate the virtual object Ov. For example, when the above-described object images exist, the virtual space management server 2 may generate the virtual object Ov by simulating the outward appearance of the real object Or captured in the object images. On the other hand, when a real object Or corresponding to a virtual object Ov does not exist, it is necessary to prepare the real object Or in some way.

As described with reference to FIG. 3, the distributed ledger D stores manufacturing information on a real object Or in association with said real object Or. Therefore, when a real object Or corresponding to the virtual object Ov purchased by the user Ur in the virtual space V does not exist, the object management system S can transmit the manufacturing information to a manufacturing location of the real object Or and manufacture the real object Or. In order to realize this, the manufacturing information stored in the distributed ledger D also stores information about a factory or the like that is capable of manufacturing the real object Or. Thus, when the user owns a new object in one of the real space R and the virtual space V, the object management system S can also prepare the object in the other space.

### <Third Usage Scene>

A third usage scene of the object management system S according to the embodiment is communication among users in the virtual space. The virtual space management server 2 represents the user Uv in the virtual space V with an object of an avatar. Suppose that a first user Uv1 in the virtual space V performed an operation to talk to a second user Uv2 who is another user in the virtual space V. At this time, in a case where the second user Uv2 is being operated by a user (that is, when the second user Ur2, who is a real user corresponding to the second user Uv2, is logged into the virtual space V), the virtual space management server 2 realizes a conversation in the virtual space V between the first user Uv1 and the second user Uv2. Specifically, the virtual space management server 2 can realize the conversation in the virtual space V between the first user Uv1 and the second user Uv2 by using a known voice call technology or chat technology.

Here, the “operation to talk to” is the user Uv's act of selecting an action “talk to” from among a plurality of actions displayed around the avatar selected in the virtual space V. When the user Uv of the avatar which was spoken to is unable to respond to the talk, he/she may instruct the virtual space management server 2 not to display the avatar, or may instruct the virtual space management server 2 to display a message, “Unable to respond until XX o'clock,” or the like when the avatar is touched with a mouse or a finger, so that the action “talk to” cannot be selected.

Further, when the first user Uv1 performs the operation to talk to the second user Uv2 and the second user Ur2 in the real space R is in an offline state, the virtual space management server 2 references the distributed ledger D and acquires the contact destination (for example, a mobile phone number, an e-mail address, a user name of a social network service (SNS), and the like) of the second user Ur2. The virtual space management server 2 notifies the acquired contact destination of the conversation offer from the first user Uv1 in the virtual space V. By doing this, the object management system S can mediate the conversation between the first user Uv1 and the second user Uv2 in the virtual space V.

The distributed ledger D may register conversation permission information indicating whether or not a user Uv in the virtual space V is willing to have a conversation or a chat using voice through the avatar. By doing this, other users Uv can confirm whether they can have a conversation with the user Uv who is willing to have a conversation. Further, the virtual space management server 2 may present an effect of making gestures as if the avatar is speaking when having a conversation by voice on the basis of the selection of the user Uv. For example, the virtual space management server 2 may provide an effect of making the avatar's face look happy or sad according to the tone of the avatar's voice and the meaning of the words the avatar spoke, or may change the expression mode of the effect depending on the meaning of the words of someone the avatar is talking to. Further, the virtual space management server 2 may display both (i) the avatar who initiated the speaking and (ii) the avatar who was spoken to on a conversation screen provided in the virtual space V.

### <Fourth Usage Scene>

A fourth usage scene of the object management system S according to the embodiment is an improvement in user experiences when transferring ownership in the virtual space V. When the virtual space V carries out an act equivalent to the exchange of ownership between users Ur (for example, the act of transferring, being transferred, buying, selling, or the like of a transaction object) in the real space R, the virtual space management server 2 registers the transfer of ownership also on the system by registering the user identifier described above in the distributed ledger D. In response to (i) signing or affixing one's stamp on a transfer contract object, (ii) an exchange of currency for trade with an object, or (iii) an operation (for example, a body gesture or the like) indicating a predetermined transfer in the virtual space V, the virtual space management server 2 may register the user identifier in the distributed ledger D and transfer the ownership. When the ownership is transferred in the virtual space V, the virtual space management server 2 may realize a specific effect (for example, playback of sound effects, some kind of visual effect such as display of characters, or the like) in the virtual space V.

The distributed ledger D may link an evaluation value to each user U and store it. Here, the “evaluation value” is a value that reflects the evaluation of the user U in at least one of the virtual space V or the real space R, and is a value that evaluates the user U's actions. The node 1 increases and decreases the evaluation value linked to said user U in accordance with the user U's actions. An evaluation value management part (not shown) in the node 1 manages the change of the evaluation value on the basis of (i) whether the user U has assisted a person asking for help, (ii) whether the user U has returned a borrowed item by its due date, (iii) whether the user U has purchased goods with high credibility in ownership, (iv) whether the user U has done a fundraising or social contribution activity such as SDGs, (v) the content of what the user U has talked about, (vi) the user U's purchase history of goods, and the like, for example. Specifically, the evaluation value management part increases the evaluation value linked to the user U when the user U has done something to improve his/her evaluation, and decreases the evaluation value linked to the user U when the user U has done something to lower his/her evaluation.

Further, when the user U transfers a real object Or or a virtual object Ov that is subject to transfer of ownership, the node 1 may have the user U browse the history data of the distributed ledger D to confirm that the object that is subject to transfer of ownership is a genuine product. In this case, the node 1 may have the user U press a “confirmed” icon (not shown) for notifying that the user U has confirmed that the object is genuine. Further, for an authentication of a seller or a buyer, the node 1 may realize a transaction on the condition of a password input, voiceprint authentication, and an authentication step using a captured image obtained by an operation device.

Although the evaluation value is linked to each user U, one user U can ensure the evaluation value of another user U. For example, a parent user U who is a parent can ensure ownership transfer of a real object Or linked to a child user U who is his/her child. Specifically, when the child user U has sold a real object Or he/she owns to another user Ur, the parent user U is responsible for the obligation of transferring the real object Or. Further, when the child user U purchases a certain real object Or, the parent user U has an obligation to pay a compensation. If the parent user U does not fulfill such an obligation or responsibility, the node 1 lowers the evaluation value of said parent user U. By doing this, the parent user U has an incentive to fulfill the obligation and responsibility in order to maintain his/her own evaluation value. As a result, the evaluation value of the child user U can be ensured by the parent user U.

As another example, although one user U does not bear any obligation or responsibility for the actions of another user U, a user with a high evaluation value can increase the evaluation value of another user U by evaluating the other user U as a “trustworthy person”. In this case, when one user U makes a gesture or the like indicating that he/she has evaluated another user U as the “trustworthy person,” the node 1 can realize increasing of the evaluation value of the user U, who is an evaluatee, in accordance with the evaluation value of the user U, who is an evaluator. In this case, if the evaluated user U commits some kind of an act that causes his/her evaluation to be lowered, the node 1 may lower the evaluation of the user U who evaluated said evaluated user U.

The present disclosure is explained based on the exemplary embodiments. The technical scope of the present disclosure is not limited to the scope explained in the above embodiments and it is possible to make various changes and modifications within the scope of the disclosure. For example, all or part of the apparatus can be configured with any unit which is functionally or physically dispersed or integrated. Further, new exemplary embodiments generated by arbitrary combinations of them are included in the exemplary embodiments. Further, effects of the new exemplary embodiments brought by the combinations also have the effects of the original exemplary embodiments.

### <Variation 1>

In the above description, the collaboration between the real object Or and the corresponding virtual object Ov is mainly described. However, by referencing the distributed ledger D, the node 1 and the virtual space management server 2 may realize (i) an interaction between real objects Or themselves and (ii) an interaction between virtual objects Ov themselves.

For example, as an example of the interaction between virtual objects Ov, suppose a virtual television station broadcasts a TV program to the second virtual object Ov2, which is the object of a television, in the virtual space V. In this case, the virtual space management server 2 may reference the distributed ledger D and cause a display part of the second virtual object Ov2 in a powered-on state in the virtual space V to display content of the TV program.

As another example, suppose the user Ur in the real space R downloads a newspaper article to the first real object Or1, which is the object of a mobile phone. In this case, the downloaded newspaper article is displayed on the first real object Or1, and also the virtual space management server 2 also causes the first virtual object Ov1 to display the newspaper article. The virtual space management server 2 may realize the downloaded newspaper article as a virtual object Ov of the newspaper in the virtual space V, if so specified by the user.

Suppose the user Ur in the real space R turns on the first real object Or1 at a timing when the user Uv is reading the newspaper on the virtual object Ov of the newspaper in the virtual space V. At this time, by referencing the distributed ledger D, the virtual space management server 2 transmits, to the first real object Or1, an operation instruction for displaying an open page of the virtual object Ov of the newspaper. By doing this, the user Ur can read the continuation of the newspaper that he/she was reading in the virtual space V with the first real object Or1. This is an example of a case where the operation of the real object Or is reflected on the virtual object Ov and the operation of the virtual object Ov is reflected on the real object Or again.

### <Variation 2>

In the above description, various types of data relating to objects are managed in the distributed ledger D. However, the present disclosure is not necessarily limited to the case where various types of data relating to objects are managed in a distributed manner. Alternatively or in addition, all or at least a part of the various types of data relating to objects may be centrally managed, such as in a conventional database.

### <Variation 3>

In the above description, cases where the real object Or in the real space R and the virtual object Ov in the virtual space V are associated with each other have been described. In addition, at least a part of the virtual object Ov may be projected onto the real space R, and three spaces, namely, (i) the real space R, (ii) the virtual space V, and (iii) a mixed reality (MR) space obtained by mixing the real space R and the virtual space V may be associated with each other. In this case, the user Ur in the real space R is provided with a transmissive video presentation device (hereinafter, referred to as an “MR device”) such as smart glasses.

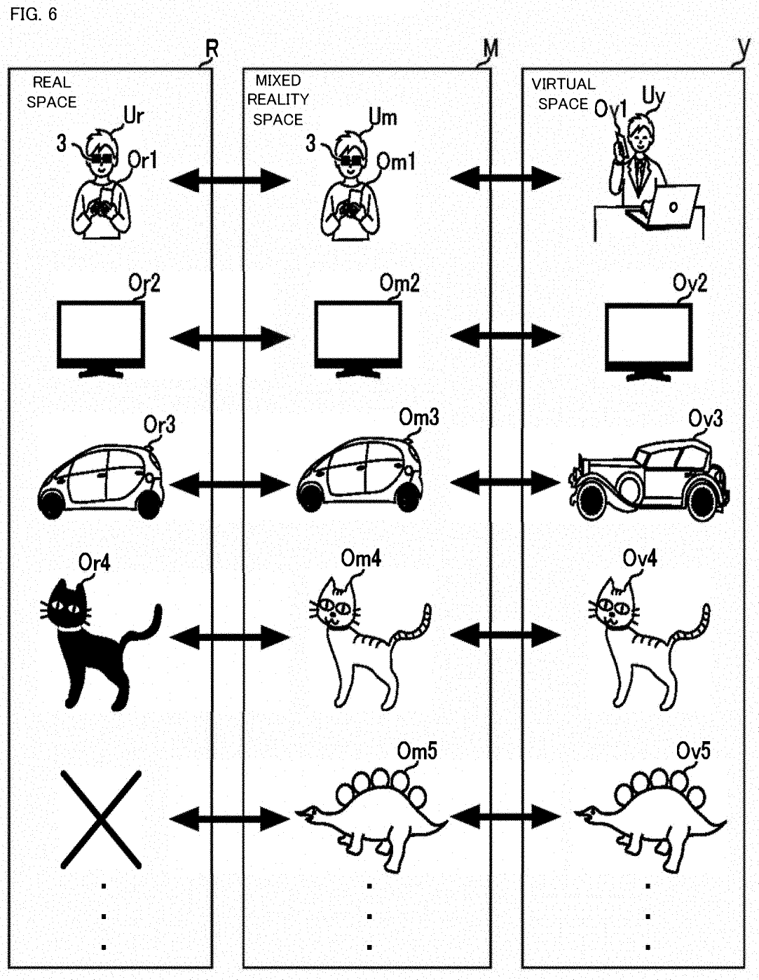

FIG. 6 illustrates a world view assumed by an object management system S according to Variation 3 of the embodiment. A virtual space management server 2 according to Variation 3 also functions as a mixed space management server for presenting the virtual object Ov to an MR device 3 worn by the user Ur in the real space R. Alternatively, in addition to the virtual space management server 2, a mixed space management server (not shown) may be provided as a new server.

As shown in FIG. 6, the mixed space management server can overwrite a video onto a real object Or via the MR device 3 in a mixed reality space M. For example, the mixed space management server superimposes a video of the fourth virtual object Ov4 on the fourth real object Or4, which is the real object Or of a cat, and presents the superimposed video to a user Um wearing the MR device 3. In this manner, the user Um can perceive the third real object Or3 as a striped tabby even though the third real object Or3 is actually a black cat.

Further, the mixed space management server can present the fifth virtual object Ov5, which is an object of prehistoric life that is extinct in the real world, to the user Um wearing the MR device 3. By doing this, the user Um can observe the fifth virtual object Ov5 as if it were alive not only in the virtual space V but also in the real space R.

Further, between two users Um who each wear the MR device 3, even if a first user Um does not actually call out to a second user Um, by having the first user Um select an option presented to the users Um via their MR devices 3 by the mixed space management server, the first user Um who called out can notify the second user Um that he/she is being called out to. At this time, even when the second user Um who was called out to cannot start communication or refuses to exchange communication for some reason, the second user Um can respond by selecting an option presented to the users Um.

Here, if the MR device 3 is provided with a gazing point detection module, the mixed management server may accept a selection of options on the basis of a gazing point position of the user U wearing the MR device 3. The gazing point detection module is a module that detects a direction of the user U's gaze, and is implemented using a known line-of-sight detection technology. In response to passing of a certain period of time in which the user U has gazed upon one of the options presented by the mixed space management server, the mixed space management server considers that option to be the selected option. Thus, the user U can select options simply by moving his/her line of sight.

Further, when the user U owns an object O such as a car in the virtual space V or in the real space R, the mixed space management server can present a video of a new possession on the MR device 3 of the user Um. By doing this, a flag indicating the user U's ownership for the object O is set, and the user Um can observe, in the mixed reality space M, the condition of the object when it is brand new, the state of the object when a color of its outward appearance is changed, or the like.

What is claimed is:

1. An object management system for managing a real object that is an object in a real space and a virtual object that is an object in a virtual space corresponding to the real object, the object management system comprising:
a plurality of nodes; and
a distributed ledger shared by each of the plurality of nodes, wherein the distributed ledger comprises:
an identifier field that stores a real identifier which is an identifier for identifying the real object and a virtual identifier which is an identifier for identifying the virtual object corresponding to the real object, in association with each other, and each of the plurality of nodes comprises:
an information receiving part that receives, from at least one of the real object or the virtual object, an identifier for identifying the object and change information about a state change including an operation of the object;
an identifier acquisition part that acquires a correspondence identifier which is an identifier of an object corresponding to the identifier, by referencing the distributed ledger;
an instruction information generator that generates instruction information for operating a corresponding object, which is the object identified by the correspondence identifier, on the basis of the change information; and
an instruction information transmitter that transmits the instruction information to the corresponding object.

2. The object management system according to claim 1, wherein the distributed ledger further comprises:
a common field that stores common information which is information common to the real object and the virtual object;
a real field that stores unique information which is information unique to the real object; and
a virtual field that stores virtual information that is information unique to the virtual object corresponding to the real object.

3. The object management system according to claim 2, wherein the distributed ledger further stores a history of change information of the real object and a history of change information of the virtual object.

4. The object management system according to claim 2, wherein the real field of the distributed ledger includes manufacturing information for manufacturing the real object.

5. The object management system according to claim 2, wherein the virtual field of the distributed ledger includes a credit score which is an index indicating reliability of the virtual object.

6. The object management system according to claim 1, wherein the distributed ledger further comprises a user field for storing a user identifier for identifying a user who is an owner of the object.

7. The object management system according to claim 1, wherein the real object can communicate with each of the plurality of nodes via a communication network.
